(19) United States
(12) Patent Application Publication
(10) Pub. No.: US 2026/0316237 A1
(43) Pub. Date: Oct. 15, 2026

(54) Tool for Crimping or Cutting a Workpiece

(71) Applicant: GUSTAV KLAUKE GMBH, Remscheid (DE)

(72) Inventors: Andreas LEHR, Neuss (DE); Egbert FRENKEN, Heinsberg (DE)

(73) Assignee: GUSTAV KLAUKE GMBH, Remscheid (DE)

(21) Appl. No.: 19/481,083

(22) PCT Filed: May 2, 2024
(86) PCT No.: PCT/EP2024/062074

§ 371 Date: Nov. 3, 2025

(30) Foreign Application Priority Data
May 5, 2023 (DE) 10 2023 111 799.8

(51) Int. Cl. B25B 27/02; B25B 29/00; B25F 5/00

(52) U.S. Cl. CPC B25B 27/026; B25B 29/00; B25F 5/005

(57) ABSTRACT

A tool is provided which has two tool jaws which receive a pair of tool parts for crimping or cutting a workpiece. The tool has a device for acting upon the jaws with an actuating pressure that causes the jaws to move together, a sensor for detecting a parameter that is proportional to the actuating pressure and a control device for evaluating the detected parameter. A luminous display of the tool is controlled by the control device based upon the detected parameter. The control device illuminates the surface area of the luminous display provides a reference to the actuating pressure reached on the basis of the ratio of illuminated surface area portions to non-illuminated surface area portions of the luminous display.

### TECHNICAL FIELD

The disclosure pertains to a tool with two tool jaws that can be moved together and serve for receiving a pair of tool parts for crimping or cutting a workpiece, wherein the tool has a device for acting upon the tool jaws with an actuating pressure that causes the tool jaws to move together, a sensor for detecting a parameter that is proportional to the actuating pressure and a control device for evaluating the detected parameter, wherein the tool has a luminous display, and wherein the control device is designed for controlling the luminous display based upon the detected parameter.

### PRIOR ART

Tools of the type in question, particularly in the form of hand tools, are known from the prior art.

EP 3 450 111 B1 (also published as US 2019/0061135A1) discloses a crimping or cutting tool with a luminous display, which serves for illuminating the tool jaws on the one hand and for displaying a device status on the other hand. The luminous display comprises RGB-LEDs that can change their color in order to display different tool information, e.g. green for a successfully completed work process, such as a crimping or cutting process, and red for a corresponding fault.

### SUMMARY OF THE DISCLOSURE

Based on the above-described the prior art, the disclosure aims to enhance a tool of the aforementioned type in such a way that the use of the tool is simplified for a user, particularly with respect to monitoring the parameters of the tool that are relevant to a work process.

This objective initially is attained with a tool of the aforementioned type, the control device of which is designed for illuminating the surface area of the luminous display proportionally based upon a progression of an increase of the actuating pressure, which is determined based on the detected parameter, wherein the luminous display provides a reference to the actuating pressure reached on the basis of the ratio of illuminated surface area portions of the luminous display to non-illuminated surface area portions of the luminous display.

According to the present disclosure, the luminous display of the tool therefore is not merely designed for displaying a success of the work process or a fault, but rather also for providing the user with additional information, particularly in the event that a fault occurs during the work process. In contrast to the prior art, the user therefore not only receives the information “operation successful” or “operation faulty,” but rather can also read additional information on the basis of the filling ratio of the luminous display. The filling ratio of the luminous display is reflected in the number of illuminated surface area portions of the luminous display and the number of non-illuminated surface area portions of the luminous display. For example, it can be assumed that the tool has been used successfully if all surface area portions of the luminous display are illuminated. However, a fault is indicated if the luminous display is only illuminated partially, wherein the filling ratio of the luminous display can then particularly provide a reference to the time or the actuating pressure of the work process, at which the fault has occurred.

The luminous display may be divided into discrete surface area portions or be designed continuously without division. A percentile scale can provide a reference to the status of the work process. Alternatively to indicating a percentage, the luminous display may also have a scale that indicates absolute parameter values, e.g. values of the actuating pressure, which causes the tool jaws to move together, or values of a detected parameter corresponding to the actuating pressure.

The luminous display may comprise a plurality of discrete luminous elements such as LEDs. The LEDs preferably can be provided in the form of RGB-LEDs and also emit red, green and blue light in addition to white light. A status of the tool therefore can be displayed by the filling ratio of the luminous display on the one hand and by the color on the other hand. In addition, a permanent or blinking display is also possible.

In addition to displaying parameters, the luminous display preferably also serves for illuminating a work area of the tool, particularly of the tool jaws that can be moved together. The luminous display initially may emit white light, preferably to the full extent of all surface area portions, before the user initiates the work process. For example, the tool may react to a mere change in position or a mechanical shock with the emission of white light in order to enable the user to illuminate the work environment. Alternatively, the user may also explicitly actuate an actuating element such as a button or a sliding switch in order to turn on the luminous display. However, it is particularly preferred that the tool has a position sensor or acceleration sensor that detects a movement of the tool, particularly in a standby state of the tool. The control device subsequently turns on the luminous display based upon the sensor signal. When the user starts the work process, particularly by actuating a correspondingly provided actuating element, the luminous display is illuminated based upon a progression of a detected parameter or a pressure increase determined therefrom, respectively. In addition, the luminous display may also switch, for example, from the color white to the color green. In the event of a fault, the luminous display may switch, for example, to the color red. Furthermore, blinking status displays are also possible in order to signal defined states, particularly critical states, of the tool.

The proportional surface area illumination of the luminous display does not necessarily have to indicate a “real-time status” of the tool. In fact, a status of the tool can also be retrieved subsequently after the completion or interruption of a work process.

It is proposed that the luminous display is a running light display, in which a number of illuminated surface area portions of the luminous display changes successively over a period of time based upon the actuating pressure. According to this embodiment, the control device not only controls the luminous display in such a way that a certain ratio of illuminated surface area portions and non-illuminated surface area portions is displayed. In fact, the filling ratio of the luminous display is variable over time. This means that the luminous display initially has no illuminated surface area portions at the start of a work process, particularly a crimping or cutting process, and the proportion of illuminated surface area portions then increases as the actuating pressure of the tool is increased such that a first surface area portion is illuminated initially, then two surface area portions, then three surface area portions, etc., until the luminous display optionally is illuminated completely once the work process has been fully and properly completed. An instantaneous status of the running light display therefore provides a reference to the actuating pressure at a certain point in time of the work process. The user receives a direct reference to the status of the work process. Furthermore, an intuitive color choice of the luminous display can provide a reference to a proper or improper status, particularly green for proper and red for improper. For example, a blinking luminous display furthermore may signal a fault or the like.

It is furthermore proposed that the control device is designed for varying the luminous display while a work process is carried out. According to this embodiment, a real-time adaptation of the luminous display takes place in such a way that the proportion of the illuminated surface area portions is varied directly while the work process is carried out. In other words, the luminous display is during a progressive pressure increase of the actuating pressure proportionally illuminated based upon the progression of the pressure increase, wherein the progressive illumination of the luminous display provides a reference to the already reached actuating pressure in the form of a ratio of the already illuminated portions of the luminous display to the not yet illuminated portions of the luminous display.

The control device may alternatively or additionally be designed in such a way that it retrieves, in response to an interrogation command of the user, data on a work process completed prior to the interrogation command, which is stored in a data memory of the tool, and subsequently illuminates surface areas of the luminous display proportionally in accordance with the pressure increase of the preceding work process stored in the data. This provides the user with the option to send a subsequent interrogation to the control device of the tool and to view the data of a preceding work process of the tool. Once the control device receives an interrogation command from the user, the data assigned to the last work process or another defined earlier work process is retrieved from the data memory of the tool and displayed on the luminous display. In this case, the luminous display preferably also displays the data in the form of a running light, in which a number of illuminated surface area portions of the luminous display changes successively over a period of time based upon the actuating pressure determined during the prior recording. In this embodiment, it is essential that the luminous display does not display any data of a work process currently still being carried out, but rather the data of an already completed work process. As an alternative to a running light display, it would naturally also be possible that the luminous display displays a status of the actuating pressure reached during the preceding work process in the form of a constant. This may take place, for example, in such a way that a number of surface area portions corresponding to the maximum pressure reached is illuminated whereas another number of surface area portions is not illuminated. Other states of the tool, particularly earlier fault states, can also be indicated in this case, e.g. in the form of a blinking luminous display in order to signal an excessive temperature of the tool, a critical state of charge of an accumulator of the tool or the like.

Furthermore, the control device may be designed in such a way that, in case a fault occurs during the pressure increase, it maintains the proportional surface area illumination of the luminous display in the state corresponding to the actuating pressure, at which the fault occurs. This embodiment is suitable for a luminous display with running lights, as well as for a luminous display that merely displays a constant value. In both instances, it is essential that the control device adjusts the proportional surface area illumination of the luminous display in such a way that the filling ratio provides information on the actuating pressure used at the time, at which the fault of the tool has occurred. The user therefore can very easily determine how far the work process did progress when the fault occurred based on the ratio of illuminated surface area portions to non-illuminated surface area portions. For example, if the luminous display shows 50% illuminated surface area portions and 50% non-illuminated surface area portions, the user can directly ascertain that the actuating pressure was built up to half of the maximum value during the work process.

The sensor for detecting a parameter that is proportional to the actuating pressure particularly may be designed for measuring a pressure, a current, a voltage, a distance or a period of time. The sensor may on the one hand directly measure the actuating pressure of the tool. In this case, the detected parameter is identical to the actuating pressure. It is not necessary to deduce the actuating pressure on the basis of the detected parameter. However, if a parameter in the form of a current, a voltage, a distance or a period of time is measured, the actuating pressure still has to be determined therefrom. This is usually realized by mathematical methods or tables. For example, a measured current or a measured voltage may be a current or a voltage of an electric motor that causes the tool jaws to move together. It is furthermore possible to detect a distance, which the tool jaws have already traveled while being moved together, and to deduce the already reached actuating pressure from this distance. It is also possible to measure a period of time, over which an actuating pressure was already exerted upon the tool jaws. The actuating pressure can also be deduced from this period of time as long as the work process proceeds properly. In order to preclude a fault, additional monitoring to the effect whether a current or a voltage of the electric motor increases or the tool jaws actually are moved together further preferably can take place in this case.

According to a preferred embodiment, the luminous display may be arranged in the region of the tool head of the tool, particularly in an annular manner around a principal longitudinal axis of a housing of the tool. In this case, the luminous display preferably is formed or arranged in a plane that is oriented orthogonal to the principal longitudinal axis. The annular luminous display may be realized in one piece or be composed of multiple parts, preferably in the form of individual luminous elements that follow one another annularly. The term annular not only refers to arrangements that are actually circular. In fact, the luminous elements may also be arranged in such a way or the luminous display as a whole may be designed in such a way that a square, a triangle, an oval or another shape is formed. It is also not necessary that the luminous display actually forms a closed ring, i.e. that the luminous display extends completely over 360° in the circumferential direction. For example, the luminous display also may include a circumference of merely 180° to 270°. Intermediate ranges between 180° and 270° that are not explicitly cited at this point, e.g. luminous displays with a circumferential extent of 190° or 225° or the like, are also possible.

The luminous display preferably is designed in such a way that it emits light, among other things, in the direction of the tool jaws. This makes it possible to respectively illuminate the tool jaws or the work area of the tool. As described above, an illumination with white light particularly is provided in this case.

The luminous display may alternatively or additionally also emit light in the radial direction of the tool such that the user can also read the luminous display while looking at the tool transverse to the principal longitudinal axis. In this embodiment, it is preferred that the luminous display comprises a plurality of luminous elements that emit light in the radial direction referred to a principal longitudinal axis of a housing of the tool.

According to another preferred embodiment, the luminous display furthermore may be designed for emitting light of different wavelengths, wherein the control device is designed for controlling the luminous display based upon a status of the work process such that it emits light with a wavelength assigned to the respective status. For example, green light can be emitted for a successfully completed work process whereas red light is emitted if a fault occurs. Other states can also be indicated with certain colors, e.g. blue for an excessively low state of charge of an accumulator or yellow for an excessively high temperature of the electric motor of the tool. Other faults naturally can also be coded with corresponding colors.

Accordingly, it would ultimately also be possible that the control device is designed for controlling the luminous display such that it displays a state of charge of an accumulator of the tool and/or a temperature of the tool.

### BRIEF DESCRIPTION OF THE DRAWINGS

The disclosure is described in greater detail below with reference to the attached drawings that merely show example embodiments. A certain component, which is described with reference to only one of the example embodiments and not replaced with a different component in another example embodiment, is therefore also described as a potentially existing component in this other example embodiment. In the respective drawings:

FIG. 1 shows a perspective view of a tool according to an embodiment with a pair of tool parts arranged in tool jaws;

FIG. 2 shows an exploded view of a luminous display of the tool in the region of the tool jaws;

FIG. 3 shows a longitudinal section through a portion of the tool along the line III in FIG. 1;

FIG. 4 shows a front view of the luminous display;

FIG. 5 shows the luminous display according to the line V in FIG. 4;

FIG. 6 shows the luminous display according to the line VI in FIG. 4;

FIG. 7 shows a state of illumination of the luminous display at a first point in time;

FIG. 8 shows a state of illumination of the luminous display at a second, later point in time;

FIG. 9 shows a perspective view of a tool according to another embodiment;

FIG. 10 shows an exploded view of a luminous display of the tool according to FIG. 9;

FIG. 11 shows a front view of the luminous display;

FIG. 12 shows the luminous display according to the line XII in FIG. 11, and

FIG. 13 shows the luminous display according to the line XIII in FIG. 11.

### DESCRIPTION OF THE EMBODIMENTS

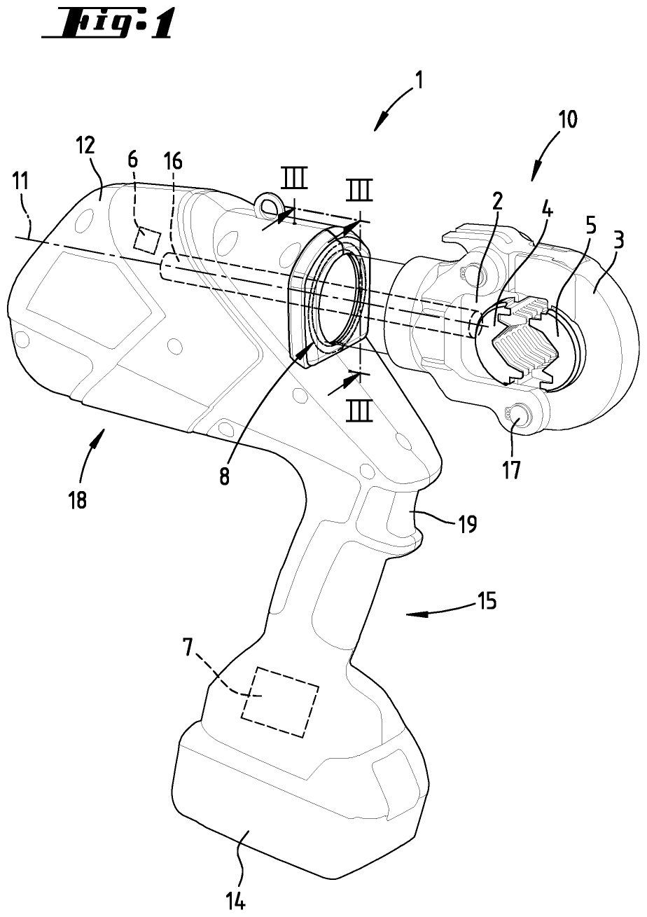

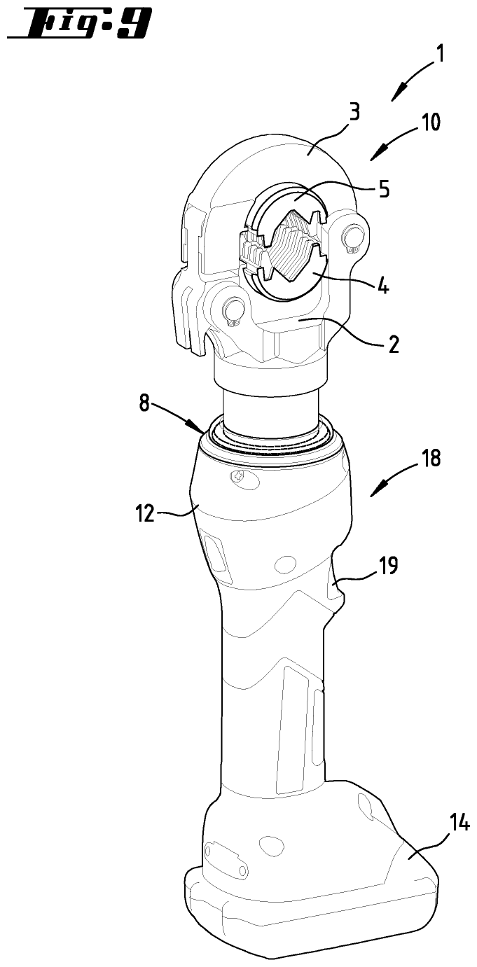

A tool 1 according to an embodiment is initially described with reference to FIG. 1, wherein the example tool shown is provided in the form of an essentially pistol-like drive unit part with a tool body 18, a handle region 15 having an actuating element 19 and a tool head 10. The tool 1 may alternatively also be provided in the form of an essentially rod-shaped drive unit part as shown in FIG. 9. The example tool 1 shown is provided in the form of a pressing tool. Alternatively, such a tool 1 may, among other things, also be a cutting tool.

The tool head 10 has first and second tool jaws 2, 3 that can be moved together to perform a work process, and are designed for receiving tool parts 4, 5, which particularly are connected to the tool jaws 2, 3 in an exchangeable manner. The tool parts 4, 5 are crimping inserts in the embodiment shown for a crimping process. However, it is alternatively also possible to equip the tool jaws 2, 3 with cutting parts in order to form a corresponding cutting tool for a cutting process. It is basically also possible to provide other tool parts 4, 5 such as tool parts 4, 5 for punching processes or for similar tasks.

The tool jaws 2, 3 are mounted on the tool body 18 formed of a housing 12, wherein the first tool jaw 2 is mounted on the tool body 18 in a linearly displaceable manner, and whereas the second tool jaw 3 can be pivoted about a joint 17 of the tool head 10 in order to open the two tool jaws 2, 3 to enable a user to remove the tool parts 4, 5 from the tool jaws 2, 3.

The tool jaw 2 and its tool part 4 received therein can be moved toward the tool jaw 3 and its tool part 5 received there, in that the linearly displaceable tool jaw 2 is displaced toward the opposite tool jaw 3. This can be realized, for example, with the aid of a hydraulic force. To this end, a piston 16 is displaced relative to the tool body 18 in this example. The piston 16 and therefore also the tool jaw 2 and it tool part 4 are driven by an electric hydraulic medium pump and a control device 7. The user of the tool 1 can start the pump, for example, by the actuating element 19. Furthermore, an accumulator 14 is provided for the energy supply of the tool 1, particularly the pump and other electric or electronic devices. The electrical energy may alternatively also be supplied via a cable connection, wherein the design of the tool 1 with an integrated accumulator 14 is preferred. The accumulator 14 may be provided in the handle region 15.

The tool 1 could alternatively also have a spindle drive. A pressing tool of this type is known, for example, from WO 2014/009363 A1 (U.S. Pat. No. 10,468,847 B2).

The tool parts 4, 5 of the embodiment shown are in this example designed for crimping together a crimping part and a stripped cable. In order to monitor the proper operation of the tool 1 and therefore also the work process, the tool 1 has a sensor 6 that, according to an embodiment, determines an actuating pressure, which causes the tool jaws 2, 3 to move together, or a parameter that is proportional to this actuating pressure. The sensor 6 is connected to the control device 7 of the tool 1, which evaluates the parameters detected by the sensor 6. The sensor 6 may be mounted in the housing 12.

The tool 1 furthermore has a luminous display 8 on the housing 12 in the region of the tool head 10, wherein the luminous display 8 includes a plurality of luminous elements 13 that form surface area portions 9 of the luminous display 8. In this example, the luminous display 8 is formed annularly around a principal longitudinal axis 11 of the housing 12 of the tool 1, and may be formed as a ring. As shown, the luminous display 8 is between the housing 12 and the tool head 10. The luminous display 8 serves for displaying the parameter detected by the sensor 6 or the actuating pressure of the tool 1 determined from this parameter. The luminous elements 13 may be spaced apart from each other, or abut against each other.

The luminous elements 13 of the luminous display 8 are formed, for example, in the form of individual light emitting diodes (LEDs) that are uniformly distributed around the principal longitudinal axis 11 of the housing 12. The LEDs are arranged in such a way to be visible or readable when viewed parallel to the principal longitudinal axis 11, as well as orthogonal to the principal longitudinal axis 11. The luminous elements 13 follow one another in the circumferential direction around the longitudinal axis 11. The control device 7 can control the luminous elements 13 like a running light display such that luminous elements 13, which follow one another in the circumferential direction, are illuminated successively. In this case, the previously illuminated luminous elements 13 either can remain illuminated or go dark as soon as the adjacent luminous element 13 emits light. The luminous display 8 may be assigned a scale that indicates, for example, a percentage between 0% and 100% or also absolute values of the measured parameter or the actuating pressure determined therefrom, e.g. a pressing power between 0 bar and 650 bar.

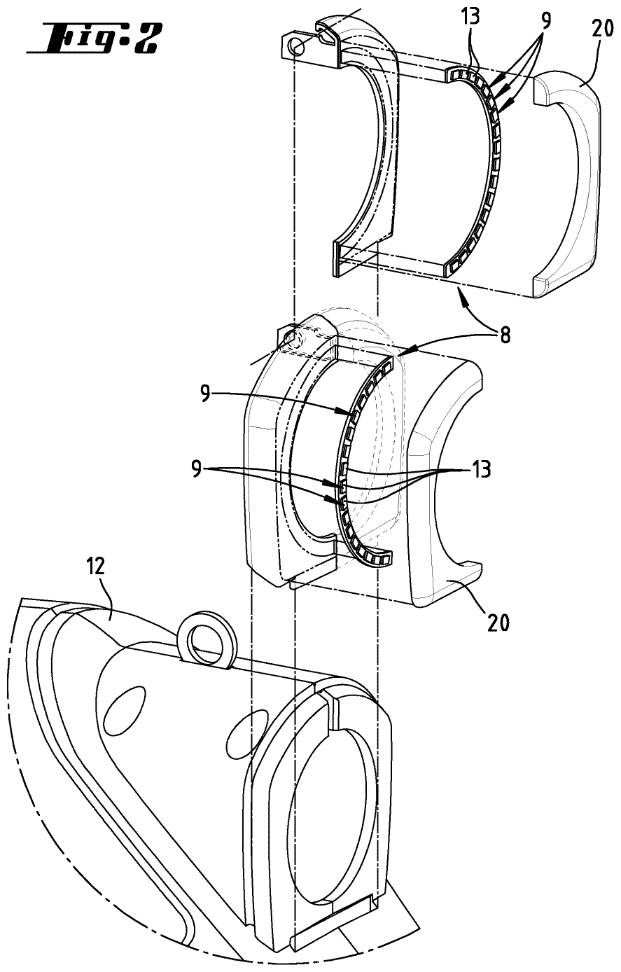

According to FIG. 2, the luminous display 8 comprises a total of thirty-four luminous elements 13. In this respect, an example pressure range of 0 to 650 bar preferably can be subdivided into thirty-four partial pressure ranges.

The control device 7 is designed for proportionally illuminating the surface area portions 9 of the luminous display 8 depending on the detected parameter or the pressure value determined therefrom. In this way, the user can obtain a reference to the actuating pressure of the tool 1 reached on the basis of a ratio of illuminated surface area portions 9 to non-illuminated surface area portions 9 of the luminous display 8.

It is furthermore possible that the luminous elements 13 are provided in the form of RGB-LEDs (light emitting diodes containing only red, green, blue lights so as to be able to illuminate a variety of colors such as red, green, blue, yellow, white) such that RGB-LEDs can be illuminated in different colors, namely red, green, blue and white. In this way, other states of the tool 1 such as a temperature of the tool 1, a state of charge of the accumulator 14 or the like can also be displayed in addition to the detected or determined actuating pressure. A blinking display of the luminous elements 13 is also possible for certain states of the tool.

The control device 7 furthermore can operate the luminous display 8 such that a work environment is illuminated, particularly the tool jaws 2, 3, by illuminating all or a number of the luminous elements 13. It is particularly preferred that the luminous display 8 initially can be controlled so as to emit white light before the actual work process begins in order to illuminate the work environment. The illumination particularly can take place in a standby state of the tool 1, in which a user has positioned the tool 1 in a work area, but not yet started a work process. The start of the work process usually takes place when the actuating element 19 is actuated. The luminous elements 13 furthermore can be illuminated in different colors in order to confirm a certain state of the tool 1, e.g. green when a work process is successfully completed or red when a fault occurs. It is furthermore possible to provide a blinking state when a fault occurs.

In an embodiment, the luminous elements 13 furthermore may emit only one color, particularly white light that serves for the illumination, as well as for displaying the tool status. The luminous display 8, e.g. the luminous elements 13 shown, is filled as the actuating pressure increases and therefore provides a reference to the actuating pressure reached so far in the form of the ratio of illuminated to non-illuminated surface area portions 9 or the position of the last luminous element 13 being illuminated. If a fault occurs, the control device 7 stops the illumination of the luminous elements 13 at the respective status, at which the fault has occurred, i.e. at the pressure corresponding to the last pressure reached.

According to an embodiment, the proportional surface area illumination of the luminous display 8 based upon the progression of the detected parameter or the actuating pressure may take place in real time, i.e. while a work process, such as a crimping process or cutting process, is carried out. However, it is alternatively or additionally also possible that the user can subsequently carry out an interrogation, wherein the control device 7 subsequently retrieves data on the previous work process, which is stored in a data memory of the tool 1, in response to a corresponding interrogation command of the user and proportionally illuminates the surface area of the luminous display 8 in accordance with the pressure increase stored in the data. In this way, the user can once again examine the pressure increase during the work process visually. In the event of a fault, the proportional surface area illumination of the luminous display 8 is in both instances (real-time display or subsequent interrogation) stopped or displayed in the state that corresponds to the actuating pressure at the instant, at which the fault has occurred.

In order to determine the actuating pressure that is essential for the control of the luminous display 8, the sensor 6 may be provided in the form of a pressure sensor, which directly measures the actuating pressure that causes the tool jaws 2, 3 to move together, i.e. toward one another. However, it is alternatively also possible that the sensor 6 detects a parameter which is proportional to the actuating pressure and from which the actuating pressure therefore can be deduced. For example, such a parameter may be a current or a voltage of the electric motor of the tool 1 or also a distance or a period of time, over which the tool jaws 2, 3 are moved toward one another. It is therefore not required that the sensor 6 is a pressure sensor. Accordingly, the sensor 6 may alternatively be current sensors, voltage sensors, distance sensors or chronometers. This listing of sensors is not exhaustive and other parameters that are proportional to the actuating pressure can also be evaluated.

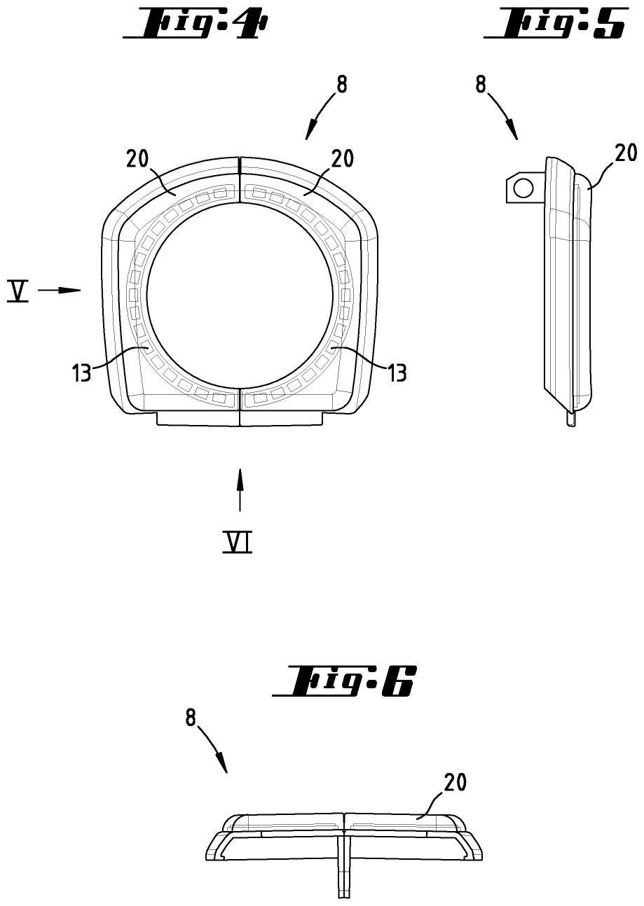

FIGS. 2 to 6 show one embodiment of the portion of the housing 12 of the tool 1 with the luminous display 8. According to this embodiment, the luminous display 8 has two identical semicircles that respectively comprise seventeen luminous elements 13. The two semicircles can be assembled into a common ring which may be continuous. In addition to a ring shape, other shapes such as oval, square, triangular, polygonal or other shapes may also be considered for the luminous display 8. In this example, the individual luminous elements 13 are provided in the form of LEDs, which are arranged in such a way that they protrude beyond a front region of the housing 12 and are visible in the direction of the principal longitudinal axis 11, as well as transverse thereto. In addition, these luminous elements 13 are covered with a transparent cover 20 which serves as mechanical protection in order to prevent damages to the luminous elements 13 and to simultaneously ensure that the luminous elements 13 can be read by a user in the direction of the principal longitudinal axis 11, as well as in the radial direction.

FIG. 3 shows a side view of the luminous display 8 with the luminous elements 13 and the cover 20. The lateral readability of the luminous elements 13 due to their protrusion beyond the housing 12 of the tool 1 is clearly visible in this figure.

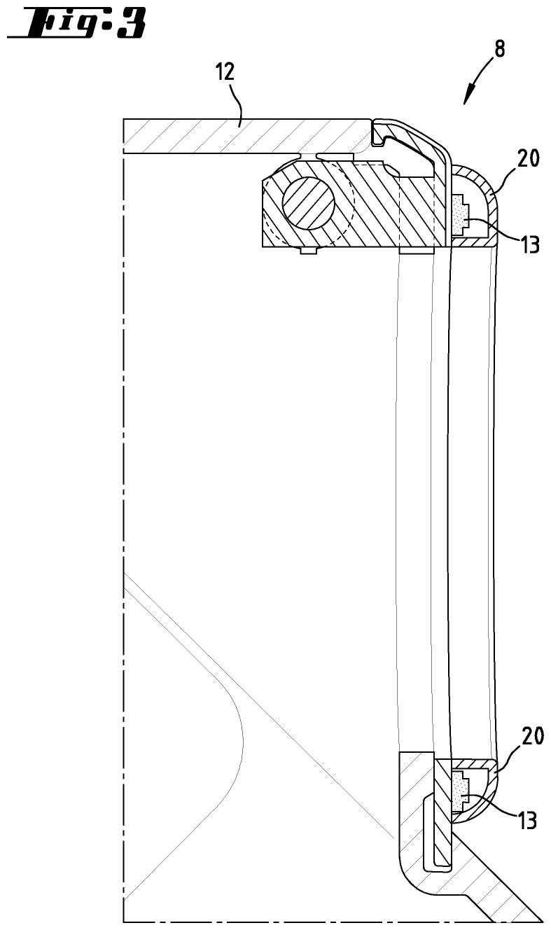

FIGS. 4 to 6 show the cover 20 in the form of a view along the principal longitudinal axis 11 or, with reference to FIG. 4, from the left and from below.

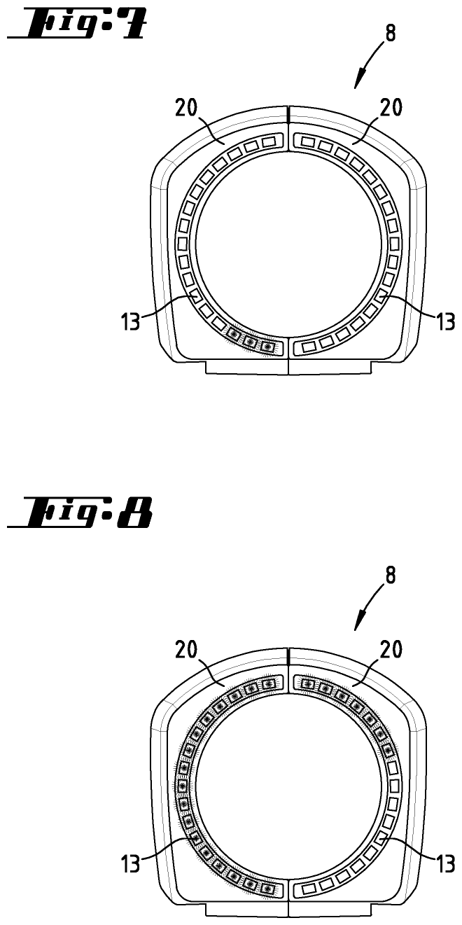

FIGS. 7 and 8 show different states of illumination of the plurality of luminous elements 13 of the luminous display 8. The illuminated and non-illuminated luminous elements 13 illustrate an actuating pressure reached during a work process of the tool, for example a crimping process, a cutting process or a punching process and the like. In this case, FIG. 7 shows an earlier state than FIG. 8. The actuating pressure can be determined on the basis of the ratio between illuminated and non-illuminated luminous elements 13, i.e. on the basis of the ratio of illuminated to non-illuminated surface area portions 9 of the luminous display 8. Only three luminous elements 13 are illuminated in FIG. 7, whereas significantly more luminous elements 13 emit light in FIG. 8. The user of the tool 1 therefore is informed of the fact that the actuating pressure in the situation according to FIG. 8 has increased in comparison with the actuating pressure according to FIG. 7.

The function of the tool 1 is described in greater detail below.

When the user turns on the tool 1 or moves the tool 1 in a standby state, the luminous display 8 can initially illuminate a work environment of the tool 1. To this end, the control device 7 controls the luminous display 8 in such a way that all luminous elements 13, or a number of luminous elements 13, are illuminated. The light emitted by the luminous elements 13 is preferably or among other things directed onto the tool head 10 or onto a workpiece that is received therein and, for example, should be crimped together with a crimping part or cut by the cutting parts or punched by the punching parts. The control device 7 can evaluate, for example, the signal of the sensor 6, for example a position sensor or acceleration sensor, of the tool 1 in order to wake up the tool 1 from the standby mode. The signals indicate that the user respectively has taken hold of or moved the tool 1 and presumably would like to carry out a work process, such as a crimping process, a cutting process, a punching process and the like.

As soon as the user starts a work process of the tool 1 by activation of the actuating element 19, the luminous elements 13 initially may go dark and then be illuminated anew, particularly individually, based upon a work progress of the tool 1. The control device 7 analyzes the data detected by the sensor 6 in order to determine the work progress. For example, the sensor 6 is a pressure sensor that measures the pressing force exerted upon the piston 16 or the tool jaws 2, 3, particularly the displaceable tool jaw 2, by the hydraulic system of the tool 1. In addition to other embodiments, it is alternatively also possible that the sensor 6 measures a distance traveled by the piston 16, wherein the distance then provides information on the status of the converging movement of the tool jaws 2, 3, namely on how far the tool jaws 2, 3 were in the meantime moved toward one another. The parameter detected by the sensor 6 is proportional to the actuating pressure that causes the tool jaws 2, 3 to move together so that the actuating pressure can be reliably determined from the parameter detected by the sensor 6 and provided to the control device 7.

As soon as the control device 7 has determined the parameter or the actuating pressure, the control device 7 controls the luminous display 8 such that certain surface area portions 9 of the luminous display 8 are illuminated and other surface area portions 9 are not illuminated.

The illuminated and non-illuminated surface area portions 9 respectively include one or more of the plurality of luminous elements 13, wherein none of the luminous elements 13 emits any light yet in an initial state prior to the pressure increase. The luminous display 8 is then illuminated, particularly proportionally, as the actuating pressure increases. For example, 50% of the luminous elements 13 of the luminous display 8 preferably are illuminated when an actuating pressure amounting to 50% of the maximum actuating pressure is reached, etc.

FIGS. 7 and 8, in particular, show that the successive states of illumination of the luminous elements 13 at different points in time preferably result in a running light display, in which the ratio between the illuminated surface area portions 9 and the non-illuminated surface area portions 9 changes. The user can directly deduce the actuating pressure visually and also is informed of the fact that the work process takes place faultlessly if or as long as the running light display of the luminous elements 13 progresses and has not yet reached a hundred percent state of illumination.

According to an embodiment, the running light display of the luminous elements 13 can be displayed directly while the work process is carried out. It is alternatively or additionally also possible that the user subsequently interrogates the actuating pressure built up during a previous work process. In this case, the control device 7 accesses a data memory, in which the respective data from the sensor 6 or actuating pressures of previous work processes of the tool 1 are stored. The luminous display 8 is subsequently illuminated, preferably also in the form of a running light display, on the basis of this data, but it is likewise possible to merely display the maximum actuating pressure reached in that certain luminous elements 13 are permanently illuminated and other luminous elements 13 are not illuminated.

If a fault of the tool 1 occurs during the work process, the control device 7 stops the luminous display 8 precisely in the state that corresponds to the actuating pressure reached at the time, at which the fault has occurred. For example, the user can then ascertain that a fault of the tool 1 always occurs at a certain actuating pressure.

In addition, the control device 7 may control the luminous display 8 in such a way that certain states are illustrated in the form of a color display, a blinking of the luminous display 8, or the like. For example, the illuminated surface area portions 9 may emit red light and/or blink in the event of a fault. In contrast, the luminous display 8 may be illuminated in green when a work process is completed properly up to a maximum actuating pressure.

As mentioned above, other states of the tool 1 may be displayed by the luminous display 8 under control of the control device 7 in response to sensors. Such other states include, for example, a temperature of the tool 1, a state of charge of the accumulator 14 and the like. Different colored display modes of the luminous display 8 can also be used for such states.

It is also possible to provide other, separate optical displays in addition to the luminous display 8 shown. Furthermore, the luminous display 8 may also be provided in multiple rows, e.g. in the form of rings that are arranged concentrically inside of one another. In this example, one of the rings can permanently illuminate the tool head 10 while another ring displays the actuating pressure.

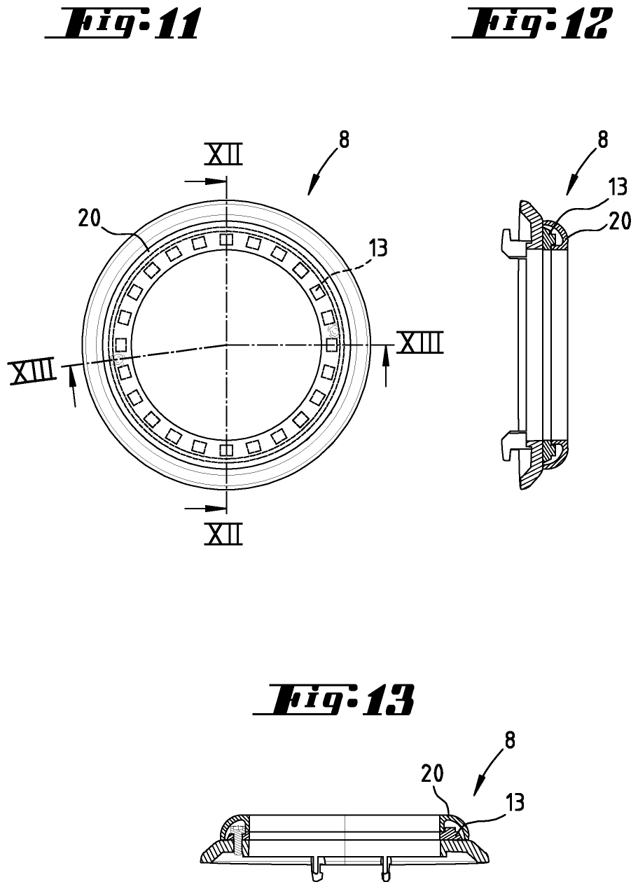

FIGS. 9 to 13 show another embodiment of the tool 1, which in this case is provided in the form of an essentially rod-like drive unit part with a tool body 18, a handle region 15 having an actuating element 19 and a tool head 10. The tool 1 has first and second tool jaws 2, 3 that in this example carry tool parts 4, 5 in the form of crimping inserts. In other respects, the equipment of the tool 1 may be designed as described above with reference to the pistol-like tool 1 according to the preceding embodiment illustrated in FIGS. 1 to 8.

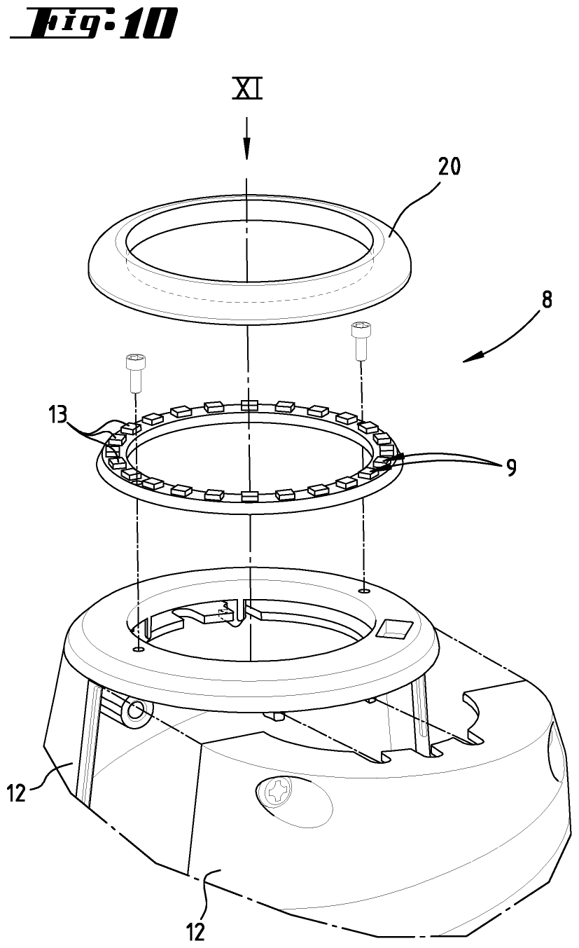

The tool 1 once again has a luminous display 8, which is illustrated in greater detail in FIGS. 10 to 13, on the housing 12 forming the tool body 18 in the region of the tool head 10. The luminous display 8 includes a plurality of luminous elements 13, which respectively form surface area portions 9 of the luminous display 8. In this example, the luminous display 8 is once again designed annularly as a ring and includes twenty-four luminous elements 13 that are arranged over an angular range of 360°.

The luminous elements 13 are once again arranged in such a way that the luminous elements 13 can be read by a user when viewed parallel to the principal longitudinal axis 11 of the tool 1, as well as orthogonal thereto. To this end, the luminous elements 13 are arranged in such a way that the luminous elements 13 protrude beyond a front contour of the housing 12 of the tool 1. The luminous elements 13 are covered by an annular transparent cover 20 that particularly serves as mechanical protection. The luminous elements 13 can still be read due to the transparent property of the cover 20.

The luminous display 8 of the embodiment of FIG. 9 particularly functions as described above with reference to the first embodiment illustrated in FIGS. 1 to 8, wherein the luminous elements 13 of the luminous display 8 are illuminated based upon the detected parameter or the pressure value determined therefrom, respectively. The surface area portions 9 of the luminous display 8 therefore are illuminated proportionally based upon the respective parameter or a pressure value. The user can obtain a reference to the actuating pressure of the tool 1 reached on the basis of the ratio of illuminated surface area portions 9 to non-illuminated surface area portions 9.

The cover 20 may be formed as partial cover portions that are connected to the housing 12 of the tool 1, or may be formed as one piece that is connected to the housing 12 of the tool 1. The partial cover portions may be formed from two symmetric portions. An example of the partial cover portions is shown in the embodiment of FIGS. 1-8 and an example of the one piece cover is shown the is shown in the embodiment of FIGS. 9-13. The luminous display 8 may be fixed on the housing 12, by screws, adhesive, a snap-on connection and the like. The cover 20 can be attached to the housing 12 of the tool 1 over the luminous display 8, by screws, adhesive, a snap-on connection and the like. Other connecting techniques can also be used for connecting the luminous display 8 to the housing 12 and for connecting the cover 20 to the housing 12 on the other hand.

The disclosure is also supplemented below with repetition of the general explanations, wherein the reference symbols also elucidate the correlations with the already described figures.

According to the present disclosure, the luminous display 8 of the tool 1 therefore is not merely designed for displaying a success of the work process or a fault, but rather also for providing the user with additional information, particularly in the event that a fault occurs during the work process. In contrast to the prior art, the user therefore not only receives the information “operation successful” or “operation faulty,” but rather can also read additional information on the basis of the filling ratio of the luminous display 8. The filling ratio of the luminous display 8 is reflected in the number of illuminated surface area portions 9 of the luminous display 8 and the number of non-illuminated surface area portions 9 of the luminous display 8. For example, it can be assumed that the tool 1 has been used successfully if all surface area portions 9 of the luminous display 8 are illuminated. However, a fault is indicated if the luminous display 8 is only illuminated partially, wherein the filling ratio of the luminous display 8 can then particularly provide a reference to the time or the actuating pressure of the work process, at which the fault has occurred.

The luminous display 8 may be divided into discrete surface area portions 9 or be designed continuously without division. A percentile scale can provide a reference to the status of the work process. Alternatively to indicating a percentage, the luminous display 8 may also have a scale that indicates absolute parameter values, e.g. values of the actuating pressure, which causes the tool jaws 2, 3 to move together, or values of a detected parameter corresponding to the actuating pressure.

The luminous display 8 may comprise a plurality of discrete luminous elements 13 such as LEDs. The LEDs preferably can be provided in the form of RGB-LEDs and also emit red, green and blue light in addition to white light. A status of the tool 1 therefore can be displayed by the filling ratio of the luminous display 8 on the one hand and by the color on the other hand. In addition, a permanent or blinking display is also possible.

In addition to displaying parameters, the luminous display 8 preferably also serves for illuminating a work area of the tool 1, particularly of the tool jaws 2, 3 that can be moved together. The luminous display 8 initially may emit white light, preferably to the full extent of all surface area portions 9, before the user initiates the work process. For example, the tool 1 may react to a mere change in position or a mechanical shock with the emission of white light in order to enable the user to illuminate the work environment. Alternatively, the user may also explicitly actuate an actuating element 19 such as a button or a sliding switch in order to turn on the luminous display 8. However, it is particularly preferred that the tool 1 has a position sensor or acceleration sensor that detects a movement of the tool 1, particularly in a standby state of the tool 1. The control device 7 subsequently turns on the luminous display 8 based upon the sensor signal. When the user starts the work process, particularly by actuating a correspondingly provided actuating element 19, the luminous display 8 is illuminated based upon a progression of a detected parameter or a pressure increase determined therefrom, respectively. In addition, the luminous display 8 may also switch, for example, from the color white to the color green. In the event of a fault, the luminous display 8 may switch, for example, to the color red. Furthermore, blinking status displays are also possible in order to signal defined states, particularly critical states, of the tool 1.

The proportional surface area illumination of the luminous display 8 does not necessarily have to indicate a “real-time status” of the tool 1. In fact, a status of the tool 1 can also be retrieved subsequently after the completion or interruption of a work process.

It is proposed that the luminous display 8 is a running light display, in which a number of illuminated surface area portions 9 of the luminous display 8 changes successively over a period of time based upon the actuating pressure. According to this embodiment, the control device 7 not only controls the luminous display 8 in such a way that a certain ratio of illuminated surface area portions 9 and non-illuminated surface area portions 9 is displayed. In fact, the filling ratio of the luminous display 8 is variable over time. This means that the luminous display 8 initially has no illuminated surface area portions 9 at the start of a work process, particularly a crimping or cutting process, and the proportion of illuminated surface area portions 9 then increases as the actuating pressure of the tool 1 is increased such that a first surface area portion 9 is illuminated initially, then two surface area portions 9, then three surface area portions 9, etc., until the luminous display 8 optionally is illuminated completely once the work process has been fully and properly completed. An instantaneous status of the running light display therefore provides a reference to the actuating pressure at a certain point in time of the work process. The user receives a direct reference to the status of the work process. Furthermore, an intuitive color choice of the luminous display 8 can provide a reference to a proper or improper status, particularly green for proper and red for improper. For example, a blinking luminous display 8 furthermore may signal a fault or the like.

It is furthermore proposed that the control device 7 is designed for varying the luminous display 8 during a work process that is currently carried out. According to this embodiment, a real-time adaptation of the luminous display 8 takes place in such a way that the proportion of the illuminated surface area portions 9 is varied directly while the work process is carried out. In other words, the luminous display 8 is during a progressive pressure increase of the actuating pressure proportionally illuminated based upon the progression of the pressure increase, wherein the progressive illumination of the luminous display 8 provides a reference to the already reached actuating pressure in the form of a ratio of the already illuminated portions of the luminous display 8 to the not yet illuminated portions of the luminous display 8.

The control device 7 may alternatively or additionally retrieve, in response to an interrogation command of the user, data on a work process completed prior to the interrogation command, which is stored in a data memory of the tool 1, and subsequently illuminates surface area potions 9 of the luminous display 8 proportionally in accordance with the pressure increase of the preceding work process stored in the data. This provides the user with the option to send a subsequent interrogation to the control device 7 of the tool 1 and to view the data of a preceding work process of the tool 1. Once the control device 7 receives an interrogation command from the user, the data assigned to the last work process or another defined earlier work process is retrieved from the data memory of the tool 1 and displayed on the luminous display 8. In this case, the luminous display 8 preferably also displays the data in the form of a running light, in which a number of illuminated surface area portions 9 of the luminous display 8 changes successively over a period of time based upon the actuating pressure determined during the prior recording. In this embodiment, it is essential that the luminous display 8 does not display any data of a work process currently still being carried out, but rather the data of an already completed work process. As an alternative to a running light display, it would naturally also be possible that the luminous display 8 displays a status of the actuating pressure reached during the preceding work process in the form of a constant. This may take place, for example, in such a way that a number of surface area portions 9 corresponding to the maximum pressure reached is illuminated whereas another number of surface area portions 9 is not illuminated. Other states of the tool 1, particularly earlier fault states, can also be indicated in this case, e.g. in the form of a blinking luminous display 8 in order to signal an excessive temperature of the tool 1, a critical state of charge of an accumulator 14 of the tool 1 or the like.

Furthermore, the control device 7 may be designed in such a way that, in case a fault occurs during the pressure increase, it maintains the proportional surface area illumination of the luminous display 8 in the state corresponding to the actuating pressure, at which the fault occurs. This embodiment is suitable for a luminous display 8 with running lights, as well as for a luminous display 8 that merely displays a constant value. In both instances, it is essential that the control device 7 adjusts the proportional surface area illumination of the luminous display 8 in such a way that the filling ratio provides information on the actuating pressure used at the time, at which the fault of the tool 1 has occurred. The user therefore can very easily determine how far the work process did progress when the fault occurred based on the ratio of illuminated surface area portions 9 to non-illuminated surface area portions 9. For example, if the luminous display 8 shows 50% illuminated surface area portions 9 and 50% non-illuminated surface area portions 9, the user can directly ascertain that the actuating pressure was built up to half of the maximum value during the work process.

The sensor 6 for detecting a parameter that is proportional to the actuating pressure particularly may be designed for measuring a pressure, a current, a voltage, a distance or a period of time. The sensor 6 may on the one hand directly measure the actuating pressure of the tool 1. In this case, the detected parameter is identical to the actuating pressure. It is not necessary to deduce the actuating pressure on the basis of the detected parameter. However, if a parameter in the form of a current, a voltage, a distance or a period of time is measured, the actuating pressure still has to be determined therefrom. This is usually realized by means of mathematical methods or tables. For example, a measured current or a measured voltage may be a current or a voltage of an electric motor that causes the tool jaws 2, 3 to move together. It is furthermore possible to detect a distance, which the tool jaws 2, 3 have already traveled while being moved together, and to deduce the already reached actuating pressure from this distance. It is also possible to measure a period of time, over which an actuating pressure was already exerted upon the tool jaws 2, 3. The actuating pressure can also be deduced from this period of time as long as the work process proceeds properly. In order to preclude a fault, additional monitoring to the effect whether a current or a voltage of the electric motor increases or the tool jaws 2, 3 actually are moved together further preferably can take place in this case.

According to a preferred embodiment, the luminous display 8 may be arranged in the region of the tool head of the tool 1, particularly in an annular manner around a principal longitudinal axis 11 of a housing 12 of the tool 1. In this case, the luminous display 8 preferably is formed or arranged in a plane that is oriented orthogonal to the principal longitudinal axis 11. The annular luminous display 8 may be realized in one piece or be composed of multiple parts, preferably in the form of individual luminous elements 13 that follow one another annularly. The term annular not only refers to arrangements that are actually circular. In fact, the luminous elements 13 may also be arranged in such a way or the luminous display 8 as a whole may be designed in such a way that a square, a triangle, an oval or another shape is formed. It is also not necessary that the luminous display 8 actually forms a closed ring, i.e. that the luminous display extends completely over 360° in the circumferential direction. For example, the luminous display 8 also may include a circumference of merely 180° to 270°. Intermediate ranges between 180° and 270° that are not explicitly cited at this point, e.g. luminous displays 8 with a circumferential extent of 190° or 225° or the like, are also possible.

The luminous display 8 preferably is designed in such a way that it emits light, among other things, in the direction of the tool jaws 2, 3. This makes it possible to respectively illuminate the tool jaws 2, 3 or the work area of the tool 1. As described above, an illumination with white light particularly is provided in this case.

The luminous display 8 may alternatively or additionally also emit light in the radial direction of the tool 1 such that the user can also read the luminous display 8 while looking at the tool 1 transverse to the principal longitudinal axis 11. In this embodiment, it is preferred that the luminous display comprises a plurality of luminous elements 13 that emit light in the radial direction referred to a principal longitudinal axis 11 of a housing 12 of the tool 1.

According to another preferred embodiment, the luminous display 8 furthermore may be designed for emitting light of different wavelengths, wherein the control device 7 is designed for controlling the luminous display 8 based upon a status of the work process such that luminous display 8 emits light with a wavelength assigned to the respective status. For example, green light can be emitted for a successfully completed work process whereas red light is emitted if a fault occurs. Other states can also be indicated with certain colors, e.g. blue for an excessively low state of charge of an accumulator 14 or yellow for an excessively high temperature of the electric motor of the tool 1. Other faults naturally can also be coded with corresponding colors.

Accordingly, it would ultimately also be possible that the control device 7 is designed for controlling the luminous display 8 such that it displays a state of charge of an accumulator 14 of the tool 1 and/or a temperature of the tool 1.

### LIST OF REFERENCE SYMBOLS

1 Tool
2 Tool jaw
3 Tool jaw
4 Tool part
5 Tool part
6 Sensor
7 Control device
8 Luminous display
9 Surface area portion
10 Tool head
11 Principal longitudinal axis
12 Housing
13 Luminous element
14 Accumulator
15 Handle region
16 Piston
17 Joint
18 Tool body
19 Actuating switch
20 Cover

1-14. (canceled)

15. A tool comprising:
two tool jaws which are movable together, the tool jaws being configured to receive a pair of tool parts for crimping or cutting a workpiece;
a device configured to act upon the tool jaws with an actuating pressure that causes the tool jaws to move together;
a sensor configured to detect a parameter that is proportional to the actuating pressure;
a luminous display;
a control device configured to evaluate the detected parameter, the control device is configured to control the luminous display based upon the detected parameter and configured to illuminate a surface area of the luminous display proportionally based upon a progression of an increase of the actuating pressure, which is determined based on the detected parameter,
wherein the luminous display is configured to provide a reference to the actuating pressure reached on the basis of a ratio of illuminated surface area portions of the luminous display to non-illuminated surface area portions of the luminous display,
wherein the luminous display is configured to serve to illuminate a work area of the tool, and
wherein the luminous display initially emits a white light before a user initiates a work process and the tool reacts to a change in position or a mechanical shock with the emission of the white light in order to enable the user to illuminate a work environment.

16. The tool according to claim 15, wherein the luminous display is arranged in an annular manner around a principle longitudinal axis of a housing of the tool.

17. The tool according to claim 15, wherein the luminous display is arranged in a plane that is oriented orthogonal to a principle longitudinal axis of a housing of the tool.

18. The tool according to claim 15,
wherein the luminous display is a running light display in which a number of illuminated surface area portions of the luminous display changes successively over a period of time based upon the actuating pressure,
wherein the control device is configured to control the luminous display such that a certain ratio of illuminated surface area portions and non-illuminated surface area portions is displayed,
wherein a filling ratio of the luminous display is variable over time,
wherein initially the luminous display has no illuminated surface area portions at a start of a work process and the proportion of illuminated surface area portions then increases as the actuating pressure of the tool is increased such that a first surface area portion is illuminated initially, then a tool surface area portions, three surface area portions until the luminous display optionally is illuminated completely once the work process has been free and properly completed.

19. The tool according to claim 15, wherein the luminous display comprises a plurality of luminous elements that emit light in a direction of the tool jaws and emit light in a radial direction with reference to a principal longitudinal axis of a housing of the tool.

20. The tool according to claim 15, wherein the luminous display is a running light display in which a number of illuminated surface area portions of the luminous display changes successively over a period of time based upon the actuating pressure.

21. The tool according to claim 15, wherein the control device is configured to vary the luminous display during a work process that is currently carried out.

22. The tool according to claim 21, wherein the work process is a cutting process or a crimping process.

23. The tool according to claim 15, wherein the sensor is configured to measure a pressure, a current, a voltage, a distance or a period of time.

24. The tool according to claim 15, wherein the control device is configured to retrieve, in response to an interrogation command of a user, data on a work process completed prior to the interrogation command, which is stored in a data memory of the tool, and subsequently is configured to illuminate surface areas of the luminous display proportionally in accordance with the pressure increase of the preceding work process stored in the data.

25. The tool according to claim 15, wherein the control device is configured such that, in case a fault occurs during the pressure increase, the control device maintains the proportional surface area illumination of the luminous display in the state corresponding to the actuating pressure, at which the fault occurs.

26. A tool comprising:
a housing defining a principle longitudinal axis;
two tool jaws which are movable together, the tool jaws being configured to receive a pair of tool parts for crimping or cutting a workpiece;
a device configured to act upon the tool jaws with an actuating pressure that causes the tool jaws to move together;
a sensor configured to detect a parameter that is proportional to the actuating pressure;
a luminous display; and
a control device configured to evaluate the detected parameter, wherein the control device is configured to control the luminous display based upon the detected parameter and configured to illuminate a surface area of the luminous display proportionally based upon a progression of an increase of the actuating pressure, which is determined based on the detected parameter,
wherein the luminous display provides a reference to the actuating pressure reached on the basis of a ratio of illuminated surface area portions of the luminous display to non-illuminated surface area portions of the luminous display,
wherein the luminous display is arranged in a region of a tool head of the tool,
wherein the luminous display is configured to illuminate a work area of the tool and is arranged in an annular manner around the principle longitudinal axis of the housing,
wherein the luminous display is arranged in a plane that is oriented orthogonal to the principle longitudinal axis,
wherein the luminous display is a running light display in which a number of illuminated surface area portions of the luminous display changes successively over a period of time based upon the actuating pressure,
wherein the control device is configured to control the luminous display such that a certain ratio of illuminated surface area portions and non-illuminated surface area portions is displayed,
wherein a filling ratio of the luminous display is variable over time,
wherein initially the luminous display has no illuminated surface area portions at a start of a work process and the proportion of illuminated surface area portions then increases as the actuating pressure of the tool is increased such that a first surface area portion is illuminated initially, then a tool surface area portions, three surface area portions until the luminous display optionally is illuminated completely once the work process has been free and properly completed.

27. The tool according to claim 26, wherein the luminous display comprises a plurality of luminous elements that emit light in a direction of the tool jaws and emit light in a radial direction in reference to the principal longitudinal axis.

28. The tool according to claim 26, wherein the control device is configured to retrieve, in response to an interrogation command of a user, data on a work process completed prior to the interrogation command, which is stored in a data memory of the tool, and subsequently illuminates surface areas of the luminous display proportionally in accordance with the pressure increase of the preceding work process stored in the data.

29. The tool according to claim 26, wherein the control device is configured such that, in case a fault occurs during the pressure increase, the control device maintains the proportional surface area illumination of the luminous display in the state corresponding to the actuating pressure, at which the fault occurs.

30. The tool according to claim 26,
wherein the luminous display is configured to emit light of different wavelengths, and
wherein the control device is configured to control the luminous display based upon a status of the work process such that the luminous display emits light with a wavelength assigned to the respective status.

31. The tool according to claim 26, wherein the control device is configured to control the luminous display such that luminous display displays a state of charge of an accumulator of the tool and/or a temperature of the tool.
